(19) United States
(12) Patent Application Publication
(10) Pub. No.: US 2013/0093661 A1
(43) Pub. Date: Apr. 18, 2013

(54) METHODS AND APPARATUS FOR FACILITATING USER INTERACTION WITH A SEE-THROUGH DISPLAY

(71) Applicant: Syed Reza Ali, Palo Alto, CA (US)

(72) Inventor: Syed Reza Ali, Palo Alto, CA (US)

(73) Assignee: NOKIA CORPORATION, Espoo (FI)

(21) Appl. No.: 13/274,896

(22) Filed: Oct. 17, 2011

(51) Int. Cl. G09G 5/00

(52) U.S. Cl. 345/156

(57) ABSTRACT

Methods and apparatus are provided in order to facilitate user interaction with an electronic device, such as a see-through display. In the context of a method, a reference plane may be determined based upon a fiducial marker presented upon a display of a mobile terminal. The method may also cause interaction information to be displayed in relation to the reference plane such that the interaction information appears to be presented upon the display of the mobile terminal and such that the interaction information at least partially occludes a user's view of the fiducial marker presented upon the display of the mobile terminal. The method may also include receiving input responsive to user input to the mobile terminal in relation to the interaction information and causing performance of an operation in response to the input based upon the interaction information.

### TECHNOLOGICAL FIELD

An example embodiment to the present invention relates generally to a method and apparatus for facilitating user interaction with an electronic device and, more particularly, to a method and apparatus for facilitating user interaction with see-through display.

### BACKGROUND

Users of electronic devices interact with those devices on a frequent and repeated basis. Accordingly, a number of different techniques have been developed to facilitate user interaction with electronic devices. These techniques may include a receipt of user input via a keypad, via a touch screen and via audible commands, to name but a few. Although various techniques for facilitating user interaction have been developed, further improvements related to fostering user interaction with electronic devices may be advantageous in order to improve upon the user experience, particularly as the use of other types of electronic devices, such as see-through displays, become more prevalent.

### BRIEF SUMMARY

Methods and apparatus are therefore provided according to an example embodiment the present invention in order to facilitate user interaction with an electronic device, such as a see-through display. In this regard, the method and apparatus of one embodiment may provide for user interaction in a manner that is intuitive to the user. As such, the user experience with an electronic device, such as a see-through display, may be improved as a result of the user interaction provided in accordance with methods and apparatus of example embodiments.

In one embodiment, a method is provided that includes determining, with a processor, a reference plane based upon a fiducial marker presented upon a display of a mobile terminal. The method of this embodiment also causes interaction information to be displayed in relation to the reference plane such that the interaction information appears to be presented upon the display of the mobile terminal and such that the interaction information at least partially occludes a user's view of the fiducial marker presented upon the display of the mobile terminal. The method of this embodiment also includes receiving input responsive to user input to the mobile terminal in relation to the interaction information and causing performance of an operation in response to the input based upon the interaction information.

The method of one embodiment may also include determining a position of the mobile terminal based upon the fiducial marker and transforming a presentation of the interaction information based upon the reference plane and the position of the mobile terminal. In this embodiment, the method may also repeatedly determine the reference plane and the position of the mobile terminal and transform the presentation of the interaction information based upon the reference plane and the position of the mobile terminal while the user's view of the fiducial marker presented upon the display of the mobile terminal is occluded. The method of one embodiment may also cause information defining the fiducial marker to be provided to the mobile terminal. In one embodiment, the method may also cause an image of the fiducial marker to be captured. In this embodiment, the determination of the reference plane may include the determination of the reference plane based upon the image of the fiducial marker.

In another embodiment, an apparatus is provided that includes at least one processor and at least one memory storing computer program code with the at least one memory and stored computer program code being configured, with the at least one processor, to cause the apparatus to at least determine a reference plane based upon a fiducial marker presented upon a display of a mobile terminal. In one embodiment, the at least one memory and stored computer program code are also configured, with the at least one processor, to cause the apparatus to cause interaction information to be displayed in relation to the reference plane such that the interaction information appears to be presented upon the display of the mobile terminal and such that the interaction information at least partially occludes a user's view of the fiducial marker presented upon the display of the mobile terminal. The at least one memory and stored computer program code of this embodiment are also configured, with the at least one processor, to cause the apparatus to receive input responsive to user input to the mobile terminal in relation to the interaction information and to cause performance of an operation in response to the input based upon the interaction information.

The at least one memory and stored computer program code of one embodiment may also be further configured, with the at least one processor, to cause the apparatus to determine a position of the mobile terminal based upon the fiducial marker and to transform a presentation of the interaction information based upon the reference plane and the position of the mobile terminal. In this embodiment, the at least one memory and stored computer program code may be further configured, with the at least one processor, to cause the apparatus to repeatedly determine the reference plane and the position of the mobile terminal and to transform the presentation of the interaction information based upon the reference plane and the position of the mobile terminal while the user's view of the fiducial marker presented upon the display of the mobile terminal is occluded. In one embodiment, the at least one memory and stored computer program code are further configured, with the at least one processor, to cause the apparatus to cause information defining the fiducial marker to be provided to the mobile terminal. The at least one memory and stored computer program code of one embodiment may be further configured, with the at least one processor, to cause the apparatus to cause an image of the fiducial marker to be captured. In this embodiment, the at least one memory and stored computer program code may be configured, with the at least one processor, to cause the apparatus to determine the reference plane by determining the reference plane based upon the image of the fiducial marker.

In a further embodiment, a computer program product is provided that includes at least one non-transitory computer-readable storage medium having computer-readable program instructions stored therein with the computer-readable program instructions including program instructions configured to determine a reference plane based upon a fiducial marker presented upon a display of a mobile terminal. The computer-readable program instructions also include program instructions configured to cause interaction information to be displayed in relation to the reference plane such that the interaction information appears to be presented upon the display of the mobile terminal and such that the interaction information at least partially occludes a user's view of the fiducial marker presented upon the display of the mobile terminal. The computer-readable program instructions also include program instructions configured to receive input responsive to user input to the mobile terminal in relation to the interaction information and program instructions configured to cause performance of an operation in response to the input based upon the interaction information.

In yet another embodiment, an apparatus is provided that includes means for determining a reference plane based upon a fiducial marker presented upon a display of a mobile terminal. The apparatus of this embodiment also includes means for causing interaction information to be displayed in relation to the reference plane such that the interaction information appears to be presented upon the display of the mobile terminal and such that the interaction information at least partially occludes a user's view of the fiducial marker presented upon the display of the mobile terminal. The apparatus of this embodiment also includes means for receiving input responsive to user input to the mobile terminal in relation to the interaction information and means for causing performance of an operation in response to the input based upon the interaction information.

In one embodiment, a method is provided that includes causing, with a processor, a fiducial marker to be displayed and receiving user input while the fiducial marker continues to be displayed. In this regard, the user input is based upon interaction information that occludes the user's view of the fiducial marker. The method of this embodiment also includes causing information regarding the user input to be provided to a see-through display.

The method of one embodiment may cause the fiducial marker to be displayed on a touchscreen. In this embodiment user input may be received by receiving the user input via the touchscreen based upon the interaction information that is not displayed on the touchscreen. In one embodiment, the method may also include receiving information defining regions or operations associated with user-selectable elements of the interaction information. The method of one embodiment may also include receiving information defining the fiducial marker to be displayed.

In another embodiment, an apparatus is provided that includes at least one processor and at least one memory storing computer program code with the at least one memory and stored computer program code being configured, with the at least one processor, to cause the apparatus to at least cause a fiducial marker to be displayed and to receive user input while the fiducial marker continues to be displayed. In this regard, the user input is based upon interaction information that occludes the user's view of the fiducial marker. The at least one memory and stored computer program code of this embodiment are also configured, with the at least one processor, to cause the apparatus to cause information regarding the user input to be provided to a see-through display.

The at least one memory and stored computer program code of one embodiment may also be configured, with the at least one processor, to cause the apparatus to cause the fiducial marker to be displayed on a touchscreen. In this embodiment, the at least one memory and stored computer program code may also be configured, with the at least one processor, to cause the apparatus to receive user input by receiving the user input via the touchscreen based upon the interaction information that is not displayed on the touchscreen. The at least one memory and stored computer program code of one embodiment may also be configured, with the at least one processor, to cause the apparatus to receive information defining regions or operations associated with user-selectable elements of the interaction information. In one embodiment, the at least one memory and stored computer program code may be further configured, with the at least one processor, to cause the apparatus to receive information defining the fiducial marker to be displayed.

In a further embodiment, a computer program product is provided that includes at least one non-transitory computer-readable storage medium having computer-readable program instructions stored therein with the computer-readable program instructions including program instructions configured to cause a fiducial marker to be displayed and program instructions configured to receive user input while the fiducial marker continues to be displayed. In this regard, the user input is based upon interaction information that occludes the user's view of the fiducial marker. The computer-readable program instructions of this embodiment also include program instructions configured to cause information regarding the user input to be provided to a see-through display.

In yet another embodiment, an apparatus is provided that includes means for causing a fiducial marker to be displayed and means for receiving user input while the fiducial marker continues to be displayed. In this regard, the user input is based upon interaction information that occludes the user's view of the fiducial marker. The apparatus of this embodiment also includes means for causing information regarding the user input to be provided to a see-through display.

### BRIEF DESCRIPTION OF THE DRAWINGS

Having thus described certain example embodiments of the present invention in general terms, reference will hereinafter be made to the accompanying drawings, which are not necessarily drawn to scale, and wherein:

FIG. 1 is a perspective view of a system in accordance with one embodiment of the present invention which includes a see-through display interacting with a mobile terminal;

FIG. 2 is a block diagram of an apparatus that may be embodied by a see-through display in accordance with one embodiment of the present invention;

FIG. 3 is a block diagram of an apparatus that may be embodied by a mobile terminal in accordance with one embodiment of the present invention;

FIG. 4 is a flowchart illustrating operation performed from the perspective of a see-through display in accordance with one embodiment of the present invention;

FIG. 5 is a perspective view of a mobile terminal that is displaying a fiducial marker in accordance with one embodiment of the present invention;

FIG. 6 is a user's view through a see-through display in accordance with one embodiment to the present invention; and

FIG. 7 is a flowchart illustrating operations performed from the perspective of a mobile terminal in accordance with one embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

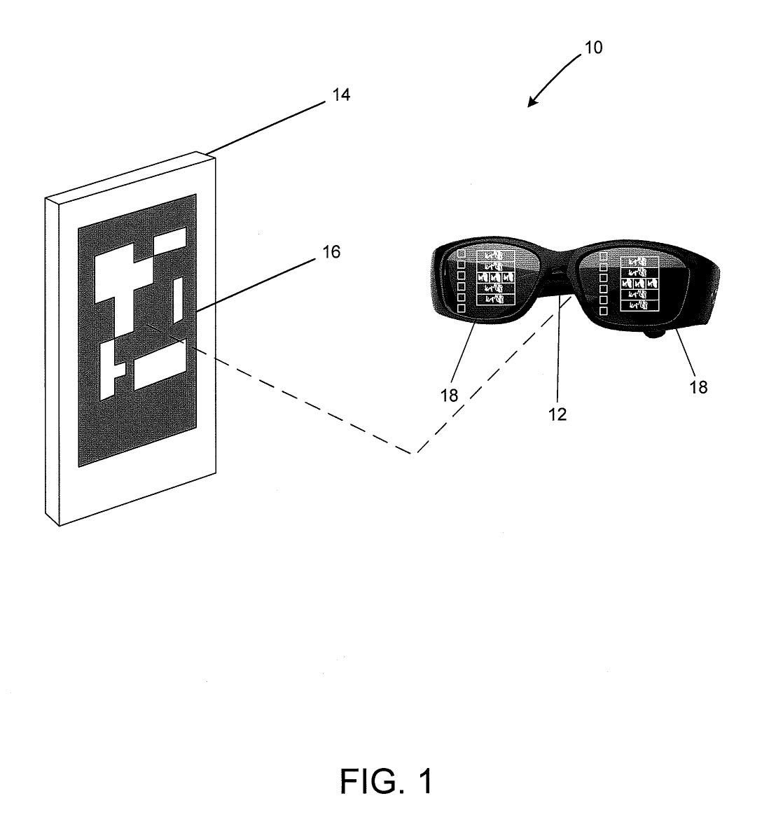

As shown in FIG. 1, a system 10 in accordance with one embodiment of the present invention may include a see-through display 12 that may be worn by a user and that may interact with a mobile terminal 14. As described below, the see-through display 12 and the mobile terminal 14 may interact in various manners but, in one embodiment, the see-through display and the mobile terminal may interact in such a manner that the user may provide input via the mobile terminal based upon interaction information that is provided by the see-through display and that appears, from the user's point of view, to be presented upon a display 16 of the mobile terminal even though the mobile terminal may continue to present other information upon the display. By providing for the interaction between the see-through display 12 and the mobile terminal 14, the method and apparatus of an embodiment of the present invention facilitate user interaction with the see-through display via the mobile terminal, thereby improving the overall user experience.

The see-through display 12 and the mobile terminal 14 may communicate in various manners including, for example, via wired communications or wireless communications. In one embodiment, the see-through display 12 and the mobile terminal 14 are configured to communication wirelessly, such as via Wi-Fi, Bluetooth or other wireless communications techniques.

A see-through display 12 may be embodied in various manners. For example, the see-through display may be a near-eye display, such as a head worn display, through which the user may optically view a scene external to the near-eye display. By way of example, a near-eye display of one embodiment is shown in FIG. 1 in the form of a pair of eyeglasses. The eyeglasses may be worn by user such that the user may view a scene, e.g., a field of view, through the lenses 18 of the eyeglasses. However, the eyeglasses of this embodiment may also be configured to present a visual representation of interaction information upon the lenses 18 so as to augment or supplement the user's view of the scene, including the user's view of the mobile terminal 14, through the lenses of the eyeglasses. As such, the eyeglasses may support augmented reality and other applications. While an example of a see-through display 12 has been provided, a see-through display may be embodied in a number of different manners with a variety of form factors, each of which may permit a user to optically see through the display so as to view the user's surroundings and each of which of which may benefit from the method, apparatus and computer program product of an example embodiment of the present invention as described below.

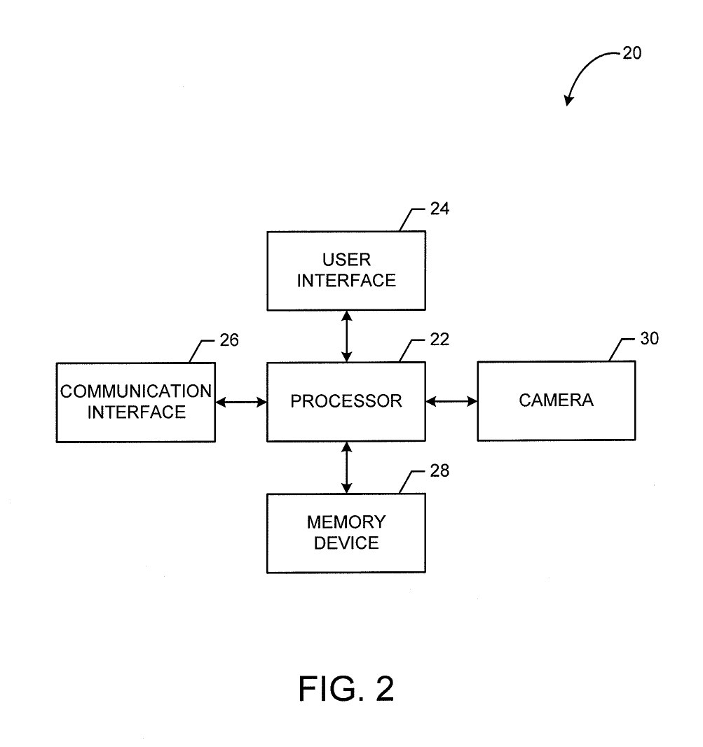

An example embodiment of the invention will now be described with reference to FIG. 2, in which certain elements of an apparatus 20 for controlling the visual representation of information upon a see-through display based, at least in part, upon a context associated with a user are depicted. The apparatus 20 of FIG. 2 may be employed, for example, in conjunction with, such as by being incorporated into or embodied by, the eyeglasses 10 of FIG. 1. However, it should be noted that the apparatus 20 of FIG. 2 may also be employed in connection with a variety of other devices and therefore, embodiments of the present invention should not be limited to application on the eyeglasses of FIG. 1.

It should also be noted that while FIG. 2 illustrates one example of a configuration of an apparatus 20 for controlling the presentation of information upon a see-through display based, at least in part, upon a context associated with a user, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 2, an apparatus 20 that may be embodied by the see-through display 12 for controlling the presentation of a visual representation of interaction information upon the see-through display, communicating with a mobile terminal 14 and responding to user input provided via the mobile terminal in response to the interaction information may include or otherwise be in communication with a processor 22, a user interface 24, such as a display, a communication interface 26, and a memory device 28. In some embodiments, the processor 22 (and/or co-processors or any other processing circuitry assisting or otherwise associated with the processor) may be in communication with the memory device 28 via a bus for passing information among components of the apparatus 20. The memory device 28 may include, for example, one or more volatile and/or non-volatile memories. In other words, for example, the memory device 28 may be an electronic storage device (e.g., a computer readable storage medium) comprising gates configured to store data (e.g., bits) that may be retrievable by a machine (e.g., a computing device like the processor 22). The memory device 28 may be configured to store information, data, content, applications, instructions, or the like for enabling the apparatus 20 to carry out various functions in accordance with an example embodiment of the present invention. For example, the memory device 28 could be configured to buffer input data for processing by the processor 22. Additionally or alternatively, the memory device 28 could be configured to store instructions for execution by the processor 22.

As shown in FIG. 1, the apparatus 20 may be embodied by a pair of eyeglasses or other see-through display 12 configured to employ an example embodiment of the present invention. However, in some embodiments, the apparatus 20 may be embodied as a chip or chip set. In other words, the apparatus 20 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 20 may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 22 may include one or more processing cores configured to perform independently. A multi-core processor may enable multiprocessing within a single physical package. Additionally or alternatively, the processor 22 may include one or more processors configured in tandem via the bus to enable independent execution of instructions, pipelining and/or multithreading.

In an example embodiment, the processor 22 may be configured to execute instructions stored in the memory device 28 or otherwise accessible to the processor. Alternatively or additionally, the processor 22 may be configured to execute hard coded functionality. As such, whether configured by hardware or software methods, or by a combination thereof, the processor 22 may represent an entity (e.g., physically embodied in circuitry) capable of performing operations according to an embodiment of the present invention while configured accordingly. Thus, for example, when the processor 22 is embodied as an ASIC, FPGA or the like, the processor may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (e.g., a see-through display 12) configured to employ an embodiment of the present invention by further configuration of the processor 22 by instructions for performing the algorithms and/or operations described herein. The processor 22 may include, among other things, a clock, an arithmetic logic unit (ALU) and logic gates configured to support operation of the processor.

Meanwhile, the communication interface 26 may be any means such as a device or circuitry embodied in either hardware or a combination of hardware and software that is configured to receive and/or transmit data from/to a network and/or any other device or module in communication with the apparatus 20, such as to support communications with the mobile terminal 14. In this regard, the communication interface 26 may include, for example, an antenna (or multiple antennas) and supporting hardware and/or software for enabling communications with a wireless communication network. Additionally or alternatively, the communication interface 26 may include the circuitry for interacting with the antenna(s) to cause transmission of signals via the antenna(s) or to handle receipt of signals received via the antenna(s). In some environments, the communication interface 26 may alternatively or also support wired communication. As such, for example, the communication interface 26 may include a communication modem and/or other hardware/software for supporting communication via cable, digital subscriber line (DSL), universal serial bus (USB) or other mechanisms.

The apparatus 20 may include a user interface 24 that may, in turn, be in communication with the processor 22 to provide output to the user. As such, the user interface 24 may include a display surface, such as the lenses of a pair of eyeglasses, a visor or the like. Alternatively or additionally, the processor 22 may comprise user interface circuitry configured to control at least some functions of one or more user interface elements such as the display surface. The processor 22 and/or user interface circuitry comprising the processor may be configured to control one or more functions of one or more user interface elements through computer program instructions (e.g., software and/or firmware) stored on a memory accessible to the processor 22 (e.g., memory device 28, and/or the like). The user interface 24 may also include hardware buttons, capacitive sensors and/or other interface elements that are configured to receive user input. For example, the user interface 24 may include a button or capacitive sensor via which the user may power the see-through display 12 on and off and/or an indicator, such as a light emitting diode (LED) indicating whether the see-through display is powered on.

The apparatus 20 may also include a camera 30 or other image capturing device. configured to capture images including images of the external environment viewed by a user through the see-through display 12. In an example embodiment, the camera 30 is in communication with the processor 22. As noted above, the camera 30 may be any means for capturing an image for analysis, display and/or transmission. For example, the camera 30 may include a digital camera capable of forming a digital image file from a captured image. As such, the camera 30 includes all hardware, such as a lens or other optical device, and software necessary for creating a digital image file from a captured image. Alternatively, the camera 30 may include only the hardware needed to view an image, while a memory device 28 of the see-through display 12 stores instructions for execution by the processor 22 in the form of software necessary to create a digital image file from a captured image. In an example embodiment, the camera 30 may further include a processing element such as a co-processor which assists the processor 22 in processing image data and an encoder and/or decoder for compressing and/or decompressing image data. The encoder and/or decoder may encode and/or decode according to a joint photographic experts group (JPEG) standard format. The images that are recorded may be stored for future analysis and/or manipulation in a memory device 28 of the see-through display 12.

With reference to FIG. 1, the system 10 may include various types of mobile terminals 14, one example of which is illustrated in FIG. 1. By way of example, but not of limitation, the mobile terminal may be a portable digital assistant (PDAs), mobile telephone, pager, mobile television, gaming device, laptop computer, camera, tablet computer, touch surface, video recorder, audio/video player, radio, electronic book, positioning device (e.g., global positioning system (GPS) device), or any combination of the aforementioned, and other types of voice and text communications systems.

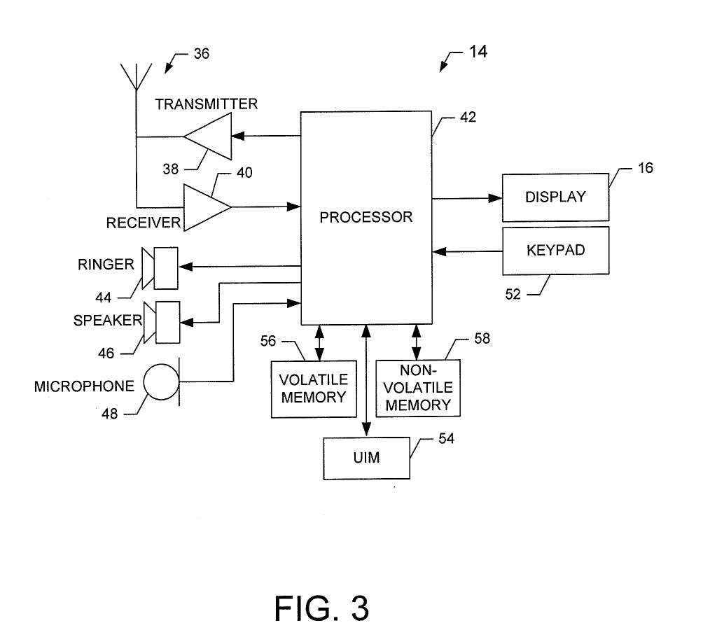

As shown in FIG. 3, the mobile terminal 14 of one embodiment may include an antenna 36 (or multiple antennas) in operable communication with a transmitter 38 and a receiver 40. The mobile terminal 14 may further include an apparatus, such as a processor 42 or other processing device, which controls the provision of signals to and the receipt of signals from the transmitter 38 and receiver 40, respectively. The signals may include signaling information in accordance with the air interface standard of the applicable cellular system, and also user speech, received data and/or user generated data. In this regard, the mobile terminal 14 is capable of operating with one or more air interface standards, communication protocols, modulation types, and access types. By way of illustration, the mobile terminal 14 is capable of operating in accordance with any of a number of first, second, third and/or fourth-generation communication protocols or the like. For example, the mobile terminal 14 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 14 may be capable of operating in accordance with non-cellular communication mechanisms. For example, the mobile terminal 14 may be capable of communication in a wireless local area network (WLAN) or other communication networks.

In some embodiments, the processor 42 may include circuitry desirable for implementing audio and logic functions of the mobile terminal 14. For example, the processor 42 may be comprised of a digital signal processor device, a microprocessor device, and various analog to digital converters, digital to analog converters, and other support circuits. Control and signal processing functions of the mobile terminal 14 are allocated between these devices according to their respective capabilities. The processor 42 thus may also include the functionality to convolutionally encode and interleave message and data prior to modulation and transmission. The processor 42 may additionally include an internal voice coder, and may include an internal data modem. Further, the processor 42 may include functionality to operate one or more software programs, which may be stored in memory. For example, the processor 42 may be capable of operating a connectivity program, such as a conventional Web browser. The connectivity program may then allow the mobile terminal 14 to transmit and receive Web content, such as location-based content and/or other web page content, according to a Wireless Application Protocol (WAP), Hypertext Transfer Protocol (HTTP) and/or the like, for example.

The mobile terminal 14 may also comprise a user interface including an output device such as a conventional earphone or speaker 46, a ringer 44, a microphone 48, a display 16, and a user input interface, all of which are coupled to the processor 42. The user input interface, which allows the mobile terminal 14 to receive data, may include any of a number of devices allowing the mobile terminal 14 to receive data, such as a keypad 52, a touch screen display (display 16 providing an example of such a touch screen display) or other input device. In embodiments including the keypad 52, the keypad 52 may include the conventional numeric (0-9) and related keys (#, *), and other hard and soft keys used for operating the mobile terminal 14. Alternatively or additionally, the keypad 52 may include a conventional QWERTY keypad arrangement. The keypad 52 may also include various soft keys with associated functions. In addition, or alternatively, the mobile terminal 14 may include an interface device such as a joystick or other user input interface. Some embodiments employing a touch screen display, as described further below, may omit the keypad 52 and any or all of the speaker 46, ringer 44, and microphone 48 entirely. The mobile terminal 14 further includes a battery, such as a vibrating battery pack, for powering various circuits that are required to operate the mobile terminal 14, as well as optionally providing mechanical vibration as a detectable output.

The mobile terminal 14 may further include a user identity module (UIM) 54. The UIM 54 is typically a memory device having a processor built in. The UIM 54 may include, for example, a subscriber identity module (SIM), a universal integrated circuit card (UICC), a universal subscriber identity module (USIM), a removable user identity module (R-UIM), etc. The UIM 54 typically stores information elements related to a mobile subscriber. In addition to the UIM 54, the mobile terminal 14 may be equipped with memory. For example, the mobile terminal 14 may include volatile memory 56, such as volatile Random Access Memory (RAM) including a cache area for the temporary storage of data. The mobile terminal 14 may also include other non-volatile memory 58, which may be embedded and/or may be removable. The memories may store any of a number of pieces of information, and data, used by the mobile terminal 14 to implement the functions of the mobile terminal 14.

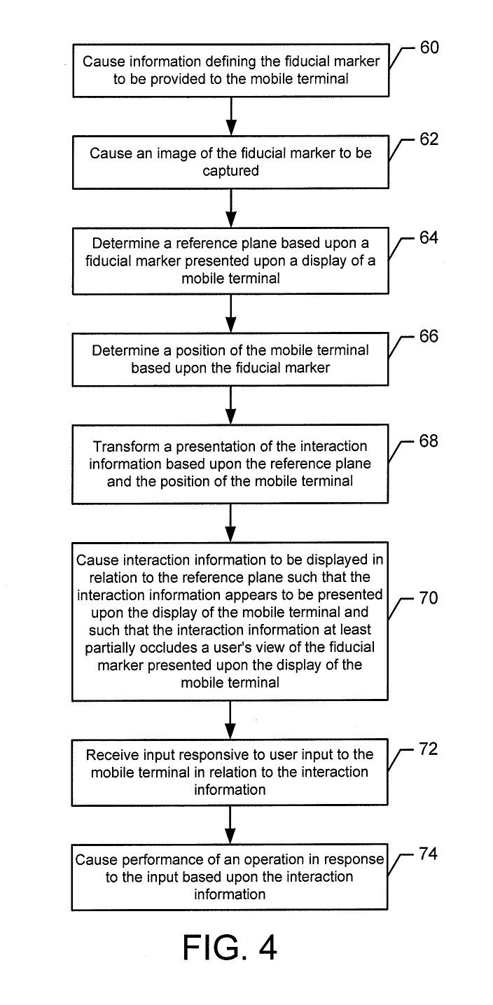

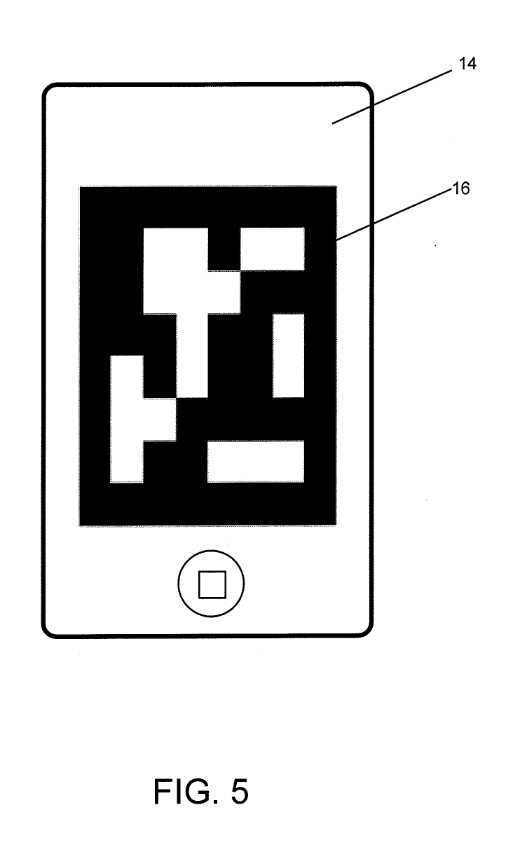

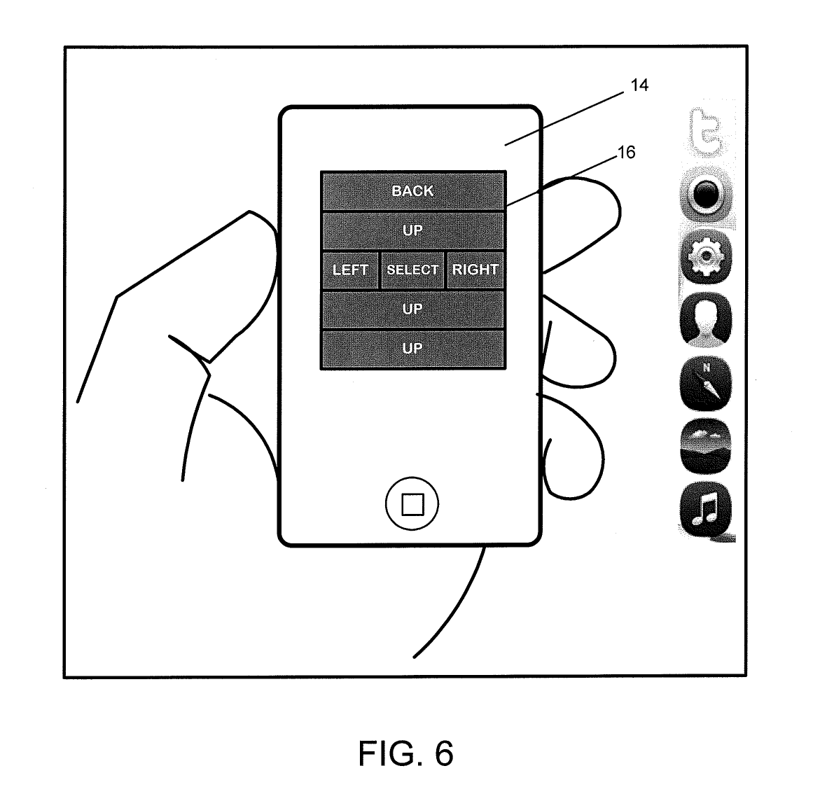

The method, apparatus 20 and computer program product of one example embodiment will now be described in conjunction with the operations illustrated in FIG. 4. In this regard, an apparatus 20 embodied by a see-through display 12 may include means, such as the processor 22 or the like, for determining a reference plane based upon a fiducial marker that is presented upon the 16 display of the mobile terminal 14. See operation 64 of FIG. 4. With reference to FIG. 5, the mobile terminal 14 may present a fiducial marker upon the display 16. Although one example of a fiducial marker is illustrated, other types of fiducial markers may be utilized. Additionally, while the fiducial marker is shown to fill the entire display 16, the fiducial marker may be presented upon only a portion of the display such that other information may be presented on the other portion(s) of the display. For example, the fiducial mareker may be square such that other user interface elements may be presented around, e.g., above and below, the fiducial marker. The other user interface elements may be selected or actuated by the user so as to provide input to the mobile terminal 14 and/or the see-through display 12. While various other user interface elements may be presented in addition to the fiducial marker, the other user interface elements of one embodiment include one or more of the menu items of the menu shown, for example, in FIG. 6 and described below so as to navigate between and select from among the applications that the see-through display 12 is configured to execute.

Regardless of the type of fiducial marker that is presented, the fiducial marker advantageously permits the position and the orientation of the display 16 of the mobile terminal 14 to be determined. In one embodiment, the apparatus 20 embodied by the see-through display 12 may include means, such as the camera 30, the processor 22 or the like, for causing an image of the fiducial marker that is presented upon the display 16 of the mobile terminal 14 to be captured. See operation 62 of FIG. 4. Based upon the image of the fiducial marker, the processor 22 may then determine the reference plane based upon the fiducial marker. The reference plane defines the orientation of the display 16 of the mobile terminal 14 and, in one embodiment, is coplanar with the display 16. The apparatus 20 embodied by the see-through display 12 may also include means, such as the processor 22 or the like, for determining the position of the display 16 of the mobile terminal 14 based upon the fiducial marker and, more particularly, based upon the image of the fiducial marker. See operation 66 of FIG. 4.

The fiducial marker and, optionally, any additional user interface elements may, in one embodiment, be provided by the see-through display 12 to the mobile terminal 14, such as via a wireless communications link, e.g., a Wi Fi, Bluetooth or other wireless communications link. In this embodiment, the apparatus 20 embodied by the see-through display 12 may include means, such as the processor 22, the communication interface 26 or the like, for causing information defining the fiducial marker to be provided to the mobile terminal 14. See operation 60 of FIG. 4. The information provided by the see-through display 12 in this embodiment may define the fiducial marker itself or may identify a fiducial marker that has previously been stored by or is otherwise accessible by the mobile terminal 14. In either instance, the mobile terminal 14 may identify the fiducial marker and, in turn, present the fiducial marker upon the display 16. Alternatively, the mobile terminal 14 may have prestored information defining one or more fiducial markers and may cause a fiducial marker to be presented upon the display 16 based upon the prestored information. However, an example embodiment of the present invention in which the apparatus 20 embodied by the see-through display 12 causes information defining the fiducial marker to be provided to the mobile terminal 14 facilitates in the synchronization of the mobile terminal and the see-through display such that the mobile terminal presents a fiducial marker upon the display of the mobile terminal that is anticipated by the see-through display.

The apparatus 20 embodied by the see-through display 12 also includes means, such as the processor 22, the communication interface 26 or the like, for causing interaction information to be displayed in relation to the reference plane such that the interaction information appears to be presented upon and/or extending out of the display 16 of the mobile terminal 14. In this regard, reference to interaction information being presented upon the display 16 encompasses interaction information being presented upon the display as well as interaction information being presented so as to appear to extend out of the display. Various types of interaction information may be displayed with the interaction information of one embodiment including one or more elements that may be selectable by a user in order to provide input, such as input to the see-through display 12. For example, the interaction information may include a menu that, in turn, includes a plurality of user-selectable menu items. Alternatively, the interaction information may include one or more icons that are selectable by a user in order to provide input.

Regardless of the type of interaction information, the apparatus 20 embodied by the see-through display 16 includes means, such as the processor 22, the user interface 24 or the like, for causing interaction information to be displayed in relation to the reference plane such that the interaction information appears to be presented upon the display 16 of the mobile terminal 14. See operation 70 of FIG. 4. In this regard, the apparatus 20 embodied by the see-through display 12 may include means, such as the processor 22 or the like, for transforming a presentation of the interaction information based upon the reference plane and, in some embodiments, also based upon the position of the mobile terminal 14. See operation 68 of FIG. 4. By way of example, the apparatus 20 embodied by the see-through display 12, such as the processor 22, may be configured to determine the reference plane and the position of the display 16 of the mobile terminal 14 based upon the fiducial marker, as described above in conjunction with operations 64 and 66 of FIG. 4. Based upon the reference plane and the position of the display 16 of the mobile terminal 14, the processor 22 may determine a transformation matrix, such as a homography matrix. The apparatus 20 embodied by the see-through display 12, such as the processor 22, may then transform the presentation of the interaction information based upon the transformation matrix as that the interaction information appears to be presented upon the display 16 of the mobile terminal 14.

As a result of the presentation of the interaction information in a manner that appears to be presented upon the display 16 of the mobile terminal 14, the interaction information at least partially occludes the user's view of the fiducial marker presented upon the display of the mobile terminal. In this regard, the interaction information may be presented upon the display surface of the see-through display 12, such as upon the lenses 18 of a pair of eye glasses that function as a see-through display as shown in FIG. 1. As such, a user viewing the display 16 of the mobile terminal 14 through the see-through display 12 will view the interaction information as presented upon the display surface of the see-through display in such a manner as to appear to the user to be presented upon the display of the mobile terminal and to at least partially and, in some embodiments, completely occlude the user's view of the fiducial marker presented upon the display of the mobile terminal. However, the interaction information is not, in fact, generated and presented by the mobile terminal 14 upon its display 16 and, instead, the mobile terminal may continue to present an image of the fiducial marker upon its display.

As a result of the continued display of the fiducial marker upon the display 16 of the mobile terminal 12, the apparatus 20 embodied by the see-through display 12, such as a camera 30, may be configured to repeatedly capture an image of the fiducial marker and to repeatedly determine the reference plane and position of the display of the mobile terminal, even while the interaction information is presented upon the display surface of the see-through display. Based upon this repeated determination the reference plane and position of the display 16 of the mobile terminal 14, the apparatus 20 embodied by the see-through display 12, such as the processor 22, may transform the presentation of the interaction information based upon the most recently determined reference plane and position in mobile terminal. As such, movement of the mobile terminal 14 while the interaction information is displayed in relation thereto may result in the presentation of the interaction information moving with the mobile terminal and adapting to changes in the pose and position of the mobile terminal such that the interaction continues to appear to be presented upon the display 16 of the mobile terminal.

In one embodiment, a mobile terminal 14 may be configured to present any one of a plurality of different fiducial markers upon its display 16. Each fiducial marker may not only permit the see-through display 12 to determine the orientation and position of the display 16 of the mobile terminal 14, but each fiducial marker may be associated with different respective interaction information. As such, the apparatus 20 embodied by the see-through display 12, such as the processor 22, may be configured to recognize the fiducial marker and not only to determine the orientation and position of the display 16 of the mobile terminal 14, but to also identify the interaction information that is associated with the respective fiducial marker such that the associated interaction information may be caused to be displayed. Thus, different interaction information may be cause to be displayed by the see-through display 12 in response to the presentation of different fiducial markers upon the display 16 of the mobile terminal 14.

The apparatus 20 embodied by the see-through display 12 may also include means, such as the communication interface 26, the processor 22 or the like, for receiving input responsive to user input to the mobile terminal 14 in relation to the interaction information. See operation 72 of FIG. 4. In one embodiment illustrated in FIGS. 1 and 6, the interaction information may represent a menu having a number of menu items that are selectable by the user. In order to select one of the menu items, the user may touch or otherwise select the menu item with a selection device, such as the user's finger, a pointer or the like. The mobile terminal 14 may, in turn, receive the user input and may then provide the input to the see-through display 12, such as via the wireless communications link established therebetween.

The input provided by the mobile terminal 14 and received by the see-through display 12, such as the communications interface 26, the processor 22 or the like, may be provided in various manners. For example, the input may simply be an indication of the position upon the display 16 of the mobile terminal 14 that was selected by the user. In this embodiment, the apparatus 20 embodied by the see-through display 12 may include means, such as the processor 22 or the like, for determining the user-selectable element, such as the menu item, the icon or the like, that corresponds to the position upon the display 16 of the mobile terminal 14 that was selected by the user. Alternatively, the input provided by the mobile terminal 14 to the see-through display 12 may be an indication of the element of the interaction information that was selected by the user. In this regard, the mobile terminal 14 may include or have access to information that define the various elements of the interaction information and the location of those elements relative to the display 16 of the mobile terminal. As such, the mobile terminal 14 may correlate the user input with the corresponding element of the interaction information and may provide the see-through display 12 with an input that identifies the element of the interaction information that was selected by the user. In another embodiment, the mobile terminal 14 may have access to information that defines the operations associated with each element of the interaction information as well as the corresponding location of each element of the interaction information upon the display 16 of the mobile terminal 14. As such, the mobile terminal 14 may correlate the user input with the respective element of the interaction information and, in turn, with the operation as associated with the respective element. The mobile terminal 14 of this embodiment may then provide the see-through display 12 with input in the form of information defining the operation associated with the user selection.

Regardless of the manner in which the input is received by the see-through display 12, the apparatus 20 embodied by the see-through display may include means, such as the processor 22 or the like, for causing performance of an operation in response to the input based upon the interaction information. See operation 74 of FIG. 4. In this regard, the apparatus 20 embodied by the see-through display 12, such as the processor 22, may determine the operation that is associated with the selection that has been made by the user in an embodiment in which the mobile terminal 14 provides the input in the form of a position upon the display 50 at which the user selection was made. For example, the apparatus 20 embodied by the see-through display 12, such as the processor 22, may be configured to correlate the position of the user selection with a corresponding element of the interaction information and, in turn, may identify the operation associated with the corresponding element of the interaction information.

Alternatively, in an embodiment in which the mobile terminal 14 provides the input in the form of information defining the element of the interaction information that was selected by the user, the apparatus 20 embodied by the see-through display 12, such as a processor 22, may be configured to identify the operation associated with the element of the interaction information that has been selected by the user. Still further, in the embodiment in which the mobile terminal 14 provides input in the form of information identifying the operation to be performed, the apparatus 20 embodied by the see-through display 12, such as the processor 22, may directly identify the operation to be performed from the input provided by the mobile terminal.

The operation that is caused to be performed may be performed by the see-through display 12. In the embodiment depicted in FIG. 6, for example, the interaction information may define a menu that includes a number of menu elements associated with the navigation and selection of an application to be executed. In the illustrated embodiment, the see-through display 12 may be configured to execute a plurality of applications, each of which is represented by an icon arranged in a column along the right-hand side of the view as seen by the user through the see-through display. In order to navigate between the applications and to select an application to be executed, the user may provide input via the menu defined by the interaction information, such as by selecting up, down, back, select or the like. In response to the user's selection, the application to be executed by the see-through display 12 may be launched, such as by being executed by the processor 22. While one example of an operation to be initiated based upon user input as described above and is illustrated in conjunction with FIG. 6, the apparatus 20 embodied by the see-through display 12 may be configured to perform other operations in other embodiments.

Alternatively, the operation to be performed based upon the user selection may be an operation to be performed by the mobile terminal 14. In this regard, the apparatus 20 embodied by the see-through display 12, such as the processor 22, the communications interface 26 or the like, may be configured to cause performance of the operation by communicating with the mobile terminal 14, such as via a wireless communication link, so as to trigger performance of the operation by the mobile terminal.

In one embodiment, the apparatus 20 embodied by the see-through display 12 may alter the presentation of the interaction information in an instance in which a user is in the process of making a selection. In this regard, the camera 30 of the see-through display 12 may repeatedly capture images of the display 16 of the mobile terminal 14, such as images of the fiducial marker presented upon the display. In an instance in which a user is in the process of making a selection, a user may place their finger or other selection device near or upon the display 16 such that the image captured by the camera 30 of the see-through display 12 also includes at least a portion of the user's finger or other selection device. In order to provide the user with feedback regarding the relative placement of the user's finger to the various elements of the interaction information, the apparatus 20 embodied by the see-through display 12 may include means, such as the processor 22 or the like, for modifying the presentation of the interaction information so as to remove or mask that portion of the interaction information that would be overlaid or blocked by the user's finger or other selection device. In this regard, the apparatus 20 embodied by the see-through display 12, such as a processor 22, may analyze the image captured by the camera 30 and determine the relative position and size of the user's finger or other selection device. Based upon this determination, the apparatus 20 embodied by the see-through display 12, such as the processor 22, may remove or otherwise mask that portion of the interaction information that corresponds to or is otherwise positionally aligned with the user's finger or other selection device. Thus, a view seen by user through the see-through display 12 may provide the user with some feedback as to the position of the user's finger or other selection device with respect to various elements of the interaction information, thereby permitting the user to confirm that the user's finger or other selection device is properly positioned prior to making a selection.

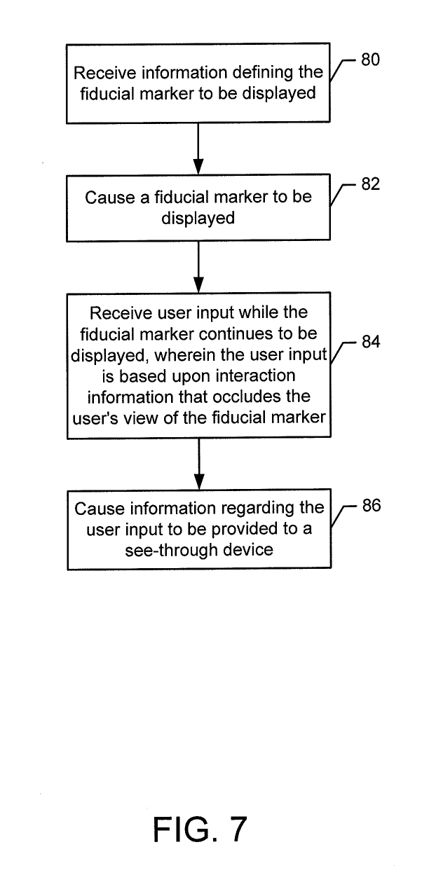

Referring now to FIG. 7 which is taken from the perspective of the mobile terminal 14, the apparatus embodied by the mobile terminal may include means, such as the processor 42, the display 16 or the like, for causing a fiducial marker to be displayed. See operation 82 of FIG. 7 as well as FIG. 5. In one embodiment in which the mobile terminal 14 includes a touchscreen display 16, the fiducial marker may be displayed upon the touchscreen. As described above, the mobile terminal 14 may include or have access to information defining the fiducial marker, such as may be prestored in memory 56, 58. Alternatively, the apparatus embodied by the mobile terminal 14 may include means, such as a processor 42, the antenna 36, the receiver 40 or the like, for receiving information defining the fiducial marker from the see-through display 12. See operation 80 of FIG. 7.

The apparatus embodied by the mobile terminal 14 may also include means, such as the processor 42, the display 16, the keypad 52 or the like, for receiving user input while the fiducial marker continues to be displayed. See operation 84 of FIG. 7. In this regard, the user input is based upon interaction information that occludes the user's view of the fiducial marker, even though the fiducial marker continues to be presented upon the display 16. In one embodiment in which the display 16 of the mobile terminal 14 is embodied as a touchscreen, the user input may be provided via the touchscreen. The apparatus embodied by the mobile terminal 14 may also include means, such as the processor 42, the transmitter 38, the antenna 36 or the like, for causing information regarding the user input to be provided to a see-through display 12. See operation 86 of FIG. 7. Various types of information regarding the user input may be provided by the mobile terminal 14. For example, the information may identify the position upon the display 16 that was selected by the user. Alternatively, the information may identify an element of the identification information that was selected by the user. In this regard, the apparatus embodied by the mobile terminal 14 may include means, such as the processor 42, the antenna 36, the receiver 40 or the like, for receiving information, such as from the see-through display 12, defining regions upon the display 16 that are associated with respective ones of the user-selectable elements of the interaction information. As such, based upon the position selected by the user, the apparatus embodied by the mobile terminal 14, such as the processor 42, may determine the region of the display that was selected and, in turn, the user-selectable element of the interaction information that corresponds to the selected region.

Alternatively, the apparatus embodied by the mobile terminal 14 may include means, such as the processor 42, the antenna 36, the receiver 40 or the like, for receiving information defining operations that are associated with the user-selectable elements of the interaction information. In this embodiment, the apparatus embodied by the mobile terminal 14, such as the processor 42, may identify the element of the interaction information that was selected, such as in the manner described above, and, based upon the element of the interaction information that was selected, may identify the operation corresponding to the selected element. The apparatus embodied by the mobile terminal 14 may, in turn, provide information regarding the selected operation to the see-through display 12, such that the operation may be caused to be performed, such as by the see-through display or the mobile terminal.

As described above, methods, apparatus and computer program products of an example embodiment permit a see-through display 12 and a mobile terminal 14 to interoperate in a manner such that a user may make selections utilizing the mobile terminal, but based upon interaction information presented by the see-through display. Accordingly, the methods, apparatus and computer program products of an example embodiment of the present invention facilitate user interaction with the see-through display 12 in an intuitive manner utilizing a mobile terminal 14, thereby improving the user experience.

As described above, FIGS. 4 and 7 illustrate flowcharts of an apparatus, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
determining, with a processor, a reference plane based upon a fiducial marker presented upon a display of a mobile terminal;
causing interaction information to be displayed in relation to the reference plane such that the interaction information appears to be presented upon the display of the mobile terminal and such that the interaction information at least partially occludes a user's view of the fiducial marker presented upon the display of the mobile terminal;
receiving input responsive to user input to the mobile terminal in relation to the interaction information; and
causing performance of an operation in response to the input based upon the interaction information.

2. A method according to claim 1 further comprising:
determining a position of the mobile terminal based upon the fiducial marker; and
transforming a presentation of the interaction information based upon the reference plane and the position of the mobile terminal.

3. A method according to claim 2 further comprising repeatedly determining the reference plane and the position of the mobile terminal and transforming the presentation of the interaction information based upon the reference plane and the position of the mobile terminal while the user's view of the fiducial marker presented upon the display of the mobile terminal is occluded.

4. A method according to claim 1 further comprising causing information defining the fiducial marker to be provided to the mobile terminal.

5. A method according to claim 1 further comprising causing an image of the fiducial marker to be captured, wherein determining the reference plane comprises determining the reference plane based upon the image of the fiducial marker.

6. An apparatus comprising at least one processor and at least one memory storing computer program code, wherein the at least one memory and stored computer program code are configured, with the at least one processor, to cause the apparatus to at least:
determine a reference plane based upon a fiducial marker presented upon a display of a mobile terminal;
cause interaction information to be displayed in relation to the reference plane such that the interaction information appears to be presented upon the display of the mobile terminal and such that the interaction information at least partially occludes a user's view of the fiducial marker presented upon the display of the mobile terminal;
receive input responsive to user input to the mobile terminal in relation to the interaction information; and
cause performance of an operation in response to the input based upon the interaction information.

7. An apparatus according to claim 6 wherein the at least one memory and stored computer program code are further configured, with the at least one processor, to cause the apparatus to:
determine a position of the mobile terminal based upon the fiducial marker; and
transform a presentation of the interaction information based upon the reference plane and the position of the mobile terminal.

8. An apparatus according to claim 7 wherein the at least one memory and stored computer program code are further configured, with the at least one processor, to cause the apparatus to repeatedly determine the reference plane and the position of the mobile terminal and transform the presentation of the interaction information based upon the reference plane and the position of the mobile terminal while the user's view of the fiducial marker presented upon the display of the mobile terminal is occluded.

9. An apparatus according to claim 6 wherein the at least one memory and stored computer program code are further configured, with the at least one processor, to cause the apparatus to cause information defining the fiducial marker to be provided to the mobile terminal.

10. An apparatus according to claim 6 wherein the at least one memory and stored computer program code are further configured, with the at least one processor, to cause the apparatus to cause an image of the fiducial marker to be captured, and wherein the at least one memory and stored computer program code are configured, with the at least one processor, to cause the apparatus to determine the reference plane by determining the reference plane based upon the image of the fiducial marker.

11. A method comprising:
causing, with a processor, a fiducial marker to be displayed;
receiving user input while the fiducial marker continues to be displayed, wherein the user input is based upon interaction information that occludes the user's view of the fiducial marker; and
causing information regarding the user input to be provided to a see-through device.

12. A method according to claim 11 wherein causing the fiducial marker to be displayed comprises causing the fiducial marker to be displayed on a touchscreen, and wherein receiving user input comprises receiving the user input via the touchscreen based upon the interaction information while the fiducial marker continues to be displayed.

13. A method according to claim 11 further comprising receiving information defining regions associated with user-selectable elements of the interaction information.

14. A method according to claim 11 further comprising receiving information defining operations associated with user-selectable elements of the interaction information.

15. A method according to claim 11 further comprising receiving information defining the fiducial marker to be displayed.

16. An apparatus comprising at least one processor and at least one memory storing computer program code, wherein the at least one memory and stored computer program code are configured, with the at least one processor, to cause the apparatus to at least:
cause a fiducial marker to be displayed;
receive user input while the fiducial marker continues to be displayed, wherein the user input is based upon interaction information that occludes the user's view of the fiducial marker; and
cause information regarding the user input to be provided to a see-through device.

17. An apparatus according to claim 16 wherein the at least one memory and stored computer program code are configured, with the at least one processor, to cause the apparatus to cause the fiducial marker to be displayed by causing the fiducial marker to be displayed on a touchscreen, and wherein the at least one memory and stored computer program code are configured, with the at least one processor, to cause the apparatus to receive user input by receiving the user input via the touchscreen based upon the interaction information while the fiducial marker continues to be displayed.

18. An apparatus according to claim 16 wherein the at least one memory and stored computer program code are further configured, with the at least one processor, to cause the apparatus to receive information defining regions associated with user-selectable elements of the interaction information.

19. An apparatus according to claim 16 wherein the at least one memory and stored computer program code are further configured, with the at least one processor, to cause the apparatus to receive information defining operations associated with user-selectable elements of the interaction information.

20. An apparatus according to claim 16 wherein the at least one memory and stored computer program code are further configured, with the at least one processor, to cause the apparatus to receive information defining the fiducial marker to be displayed.
